(19) United States
(12) Patent Application Publication
(10) Pub. No.: US 2007/0027950 A1
(43) Pub. Date: Feb. 1, 2007

(54) Encapsulated document structure, method of creating document having web server functions, and computer-readable program

(76) Inventors: Masami Mori, Tokyo (JP); Akira Suzuki, Kanagawa (JP); Takefumi Hasegawa, Tokyo (JP)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(21) Appl. No.: 11/495,669

(22) Filed: Jul. 31, 2006

(30) Foreign Application Priority Data
Aug. 1, 2005 (JP) 2005-223083

(51) Int. Cl. G06F 15/16; G06F 7/00

(52) U.S. Cl. 709/203; 707/100

(57) ABSTRACT

An encapsulated document structure includes at least one digital information file to form a representation entity, a display information file to specify a display format of the digital information file, and a program file, interpreted and executed by a computer, and including a function operation program that executes a predetermined function. The program file has Web server functions for sending the digital information file to a Web browser in response to a request from the Web browser, and the program file and the digital information file are encapsulated within a single document.

### BACKGROUND OF THE INVENTION

1. Field of the Invention

The present invention generally relates to encapsulated document structures, methods of creating documents having Web server functions, and computer-readable programs, and more particularly to an encapsulated document structure that is suited for sending information from an individual, for example, a method of creating a document having Web server functions, and a computer-readable program for causing a computer to create such a document having the Web server functions.

2. Description of the Related Art

For example, document data structures, storage media and information processing apparatus for creating encapsulated documents have been proposed in Japanese Laid-Open Patent Applications No. 2003-15941 and No. 2003-99424.

In addition, the Internet Information Service (IIS), Apache and the like have been reduced to practice as Web servers, as may be seen from the homepage http://www.atmarkit.co.jp/flinux/rensai/apache01/apache0 1.html, for example.

Due to the developments made in the Internet-related technology, it has become possible for any individual to disclose his documents, that is, open his documents to the public. Recently, blogs (or Web logs) have rapidly become popular due to the simplicity and ease with which the documents may be contributed. The contents presently existing on the Web utilize the services provided by the Internet service provider in most cases, and at the present, there are not many cases where the user forms a Web server or a global server by the user's machine to disclose information.

However, the environment in which each user forms the Web server by the user's machine to disclose information is gradually growing. As available services, there are broadband services, fixed rate always-ON (or normally connected) services, fixed IP address distribution services and the like, and the user's machines owned by the individual users nowadays have high performances (or the so-called high specs) thereby making it possible for the user's machine to operate as a server on the Internet. But even under such environments, although there are some users who form the Web server by the user's machine, the number of such users is extremely small compared to the number of users on the Internet.

The high cost and security concerns may be regarded as the causes for the very small number of user who form the Web server, but the difficulty in forming the Web server by the user's machine is also the cause. For example, if the user wishes to form the Web server by the user's machine, the user would probably utilize the Internet Information Service (IIS) provided by Microsoft or the open-source Apache, but considerable load is put on the use to make the required settings. Although the actual operation of making the required settings may not be extremely troublesome and difficult depending on the skill level of the user, the operation is regarded by the general users as being extremely troublesome and difficult.

As the broadband technology progresses and the Internet Protocol version 6 (IPv6) technology becomes more popular, an environment in which all equipments are connected to the network and have global addresses may be anticipated. In such an anticipated environment, it may be expected that the importance of sending of information from the individual or individual equipment will increase. Hence, in such an anticipated environment, it may be regarded that the user may wish to disclose documents from the user's machine, instead of utilizing the existing services of the Internet service provider.

In the case of the blog, for example, one existing service of the Internet service provider provides a space for creating the blog with respect to the user, and the user can open a blog exclusively for this user by merely making a simple registration. In this case, the user can open the blog at a low cost. But on the other hand, since the blog is opened by utilizing the service provided by the Internet service provider, the specifications of the blog are essentially non-modifiable to suit the user's tastes. In addition, the Internet service provider may suddenly discontinue the service for the blog. Moreover, there is a limit to the capacity of the images that can be registered in the blog. For these reasons, the blog that is opened by utilizing the service of the Internet service provider is not necessarily convenient for the user. If there is a simple means that is utilizable by the user to disclose the documents, the user would not have to rely on the service of the Internet service provider, but no such means presently exists.

In the case of an existing system for office use (office system) that enables the user to disclose documents, the Web server and the contents are managed by building the Web server by an information department or a user of the information department who is skilled in the Information Technology (IT) related matters, instead of having the user form the Web server by the user's machine. But the problem with such an office system is that it becomes more difficult to manage the Web server and the contents as the number of users becomes large, thereby increasing the load on the manager and the Web server and making it difficult for the user to disclose and update the contents under the user's management.

On the other hand, if the user were to manage the contents by himself, it would be unnecessary to provide the Web server in the office system, and the troublesome operations such as providing backup may be committed to the user. Furthermore, if each user were able to disclose and update the documents in a simple manner, smooth information sharing and communication may be expected within the office.

### SUMMARY OF THE INVENTION

Accordingly, it is a general object of the present invention to provide a novel and useful, encapsulated document structure, method of creating document having Web server functions, and computer-readable program, in which the problems described above are suppressed.

Another and more specific object of the present invention is to provide an encapsulated document structure, a method of creating a document having Web server functions, and a computer-readable program, which enable a user to form a Web server or a global server by the user's machine by a simple means, without requiring intervention by an Internet service provider, so that information owned by the individual user can easily be disclosed.

Still another object of the present invention is to provide an encapsulated document structure comprising at least one digital information file configured to form a representation entity; and a program file configured to include a Web server function that sends the digital information file to a Web browser in response to a request from the Web browser, wherein the program file and the digital information file are encapsulated within a single document. According to the encapsulated document structure of the present invention, it is possible to enable a user to form a Web server or a global server by the user's machine (computer) by a simple means, without requiring intervention by an Internet service provider, so that information owned by the individual user can easily be disclosed.

A further object of the present invention is to provide an encapsulated document structure comprising at least one digital information file configured to form a representation entity; a display information file configured to specify a display format of the digital information file; and a program file, interpreted and executed by a computer, and configured to include a function operation program that executes a predetermined function, wherein the program file has Web server functions for sending the digital information file to a Web browser in response to a request from the Web browser, and the program file and the digital information file are encapsulated within a single document. According to the encapsulated document structure of the present invention, it is possible to enable a user to form a Web server or a global server by the user's machine (computer) by a simple means, without requiring intervention by an Internet service provider, so that information owned by the individual user can easily be disclosed.

Another object of the present invention is to provide a method of creating a document having Web server functions, comprising describing a manifest file; specifying a class file within the manifest file; and encapsulating within a single document the manifest file and content, and a program file having Web server functions and forming the class file. According to the method of the present invention, it is possible to enable a user to form a Web server or a global server by the user's machine (computer) by a simple means, without requiring intervention by an Internet service provider, so that information owned by the individual user can easily be disclosed.

Still another object of the present invention is to provide a computer-readable program for causing a computer to create a document having Web server functions, comprising a procedure causing the computer to input a description of a manifest file; a procedure causing the computer to input a specified class file within the manifest file; and a procedure causing the computer to encapsulate within a single document the manifest file and content, and a program file having Web server functions and forming the class file. According to the computer-readable program of the present invention, it is possible to enable a user to form a Web server or a global server by the user's machine (computer) by a simple means, without requiring intervention by an Internet service provider, so that information owned by the individual user can easily be disclosed.

Other objects and further features of the present invention will be apparent from the following detailed description when read in conjunction with the accompanying drawings.

### BRIEF DESCRIPTION OF THE DRAWINGS

FIG. 1 is a diagram showing a file structure for a case where an encapsulated document structure and a method of creating a document having the Web server functions according to the present invention are applied to a Java archive (Jar) file;

FIG. 2 is a diagram showing locations of class files;

FIG. 3 is a flow chart for explaining the starting of a document having functions;

FIG. 4 is a flow chart for explaining the process of a Web server program;

FIG. 5 is a flow chart for explaining the starting of a plurality of Web server programs by generating a plurality of sockets;

FIG. 6 is a flow chart for explaining the starting of a plurality of Web server programs by generating a single socket;

FIG. 7 is a diagram showing an HTML document indicating the list of started documents;

FIG. 8 is a flow chart for explaining the process of the Web server program that receives a consignment request;

FIG. 9 is a flow chart for explaining the process of the Web server program that sends the consignment request;

FIG. 10 is a diagram for explaining the processes of the Web server programs that receive the consignment request; and

FIG. 11 is a diagram for explaining the processes of the Web server programs that respectively send and receive the consignment request.

### DESCRIPTION OF THE PREFERRED EMBODIMENTS

A description will be given of embodiments of an encapsulated document structure, a method of creating a document having Web server functions, and a computer-readable program according to the present invention, by referring to the drawings.

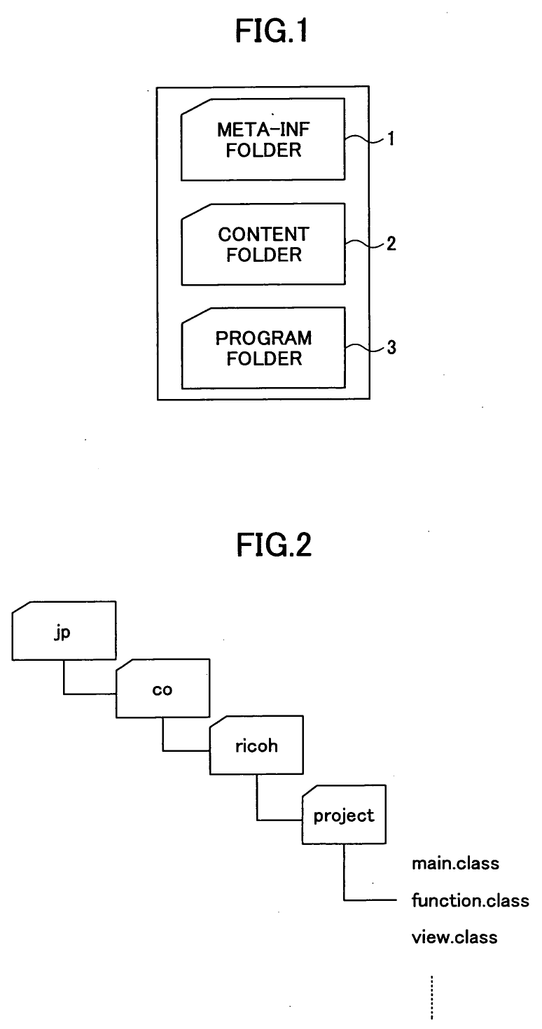

FIG. 1 is a diagram showing a file structure for a case where the encapsulated document structure and the method of creating the document having the Web server functions according to the present invention are applied to a Java archive (Jar) file.

In FIG. 1, the Jar file has a file format based on a ZIP file format that is presently used popularly, and is an archive file in which a plurality of files are grouped or collected. The Jar file may include class files, which are Java program modules, and text, image and audio files.

[Jar File Structure]

The Jar file structure is as shown in FIG. 1. In FIG. 1, a META-INF folder 1 stores a manifest file, and is written with class file information that is initially loaded at the time of the starting (or booting). A content folder 2 stores a text file, and image and/or audio file. The content folder 2 itself does not have to be provided at the location shown in FIG. 1, but in the particular case, the content folder 2 is provided at the location shown to distinguish the content folder 2 from other file groups such as program files. Of course, a plurality of content folders 2 may be provided.

A program folder 3 stores a Java program file group. Normally, the Java program is managed in a hierarchical layer according to the package name. In other words, if the packet name is “jp.co.ricoh.project”, for example, the class files that are created within this package are located at the hierarchical layers shown in FIG. 2. FIG. 2 is a diagram showing locations of class files. Accordingly, the name of the program folder 3 in this case is “jp”.

[Executable Jar File]

An executable Jar file is a file that is executed by loading the class files written in the manifest file by a double-click, similarly to the case where the double-click is made to open a file on the Windows by Microsoft, for example. The Jar file is related to a Jar file (extension jar) when installing the Java execution environment. In addition, the Jar file may be started by a command line “java-jar sample.jar”.

[Starting of Document Having Functions]

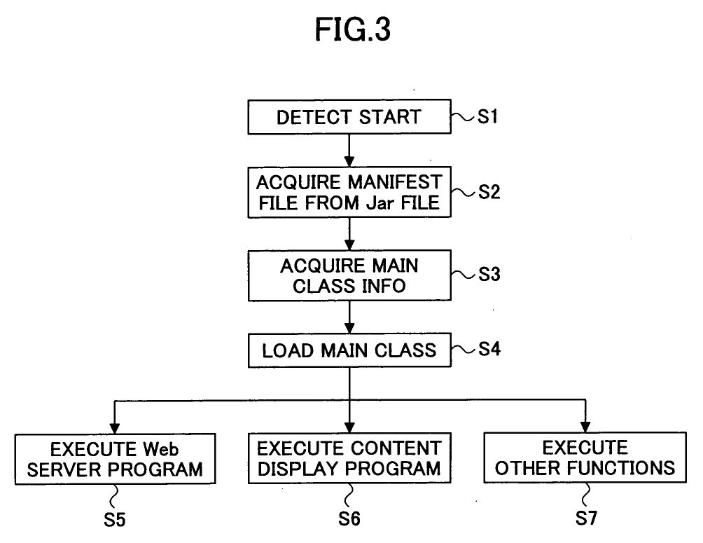

FIG. 3 is a flow chart for explaining the starting of a document having functions. The process shown in FIG. 3 is basically the same as starting the executable Jar file.

The document having the functions has the following structure comprising:

Manifest file written with the name of the program (class file) that is initially loaded when starting the document;

Content that is loaded and displayed by the program, such as text, image, dynamic image and audio files (content may have any format as long as the program is interpretable); and

Program including the program that loads and displays the document (text, image, etc.) included in the content folder, and a program that adds to the document various functions such as a communication function, a correcting and/or revising function and a recording function.

[Operation]

A step S1 shown in FIG. 3 detects the starting of the document having the functions by a command from the command line or a double click of a mouse of a computer system. A step S2 acquires the manifest file from the Jar file. A step S3 acquires information of a main class. A step S4 loads the class files that are written in the main class, so as to execute the respective class files. Hence, a step S5 executes a Web server program, a step S6 executes a content display program, and a step S7 executes other functions. Accordingly, the text and images within the content folder are displayed on a display part of the computer system.

Therefore, the content is displayed, and the program for realizing various functions is similarly loaded, to thereby make the preparations such that the document is ready for use. As a result, in response to a mouse operation made by the user, it is possible to realize a function such as inserting an underline within the document.

Next, a description will be given of a document having Web server functions. The document having the Web server functions stores, in a portion corresponding to the content, a format that is inspectable by the Web browser, such as the Hyper Text Markup Language (HTML) and the Joint Photographic Experts Group (JPEG), and stores in a portion corresponding to the program, a program for displaying the content and a Web server program for sending a content file to the Web browser depending on an access from the Web browser.

[General Process of Web Server Program]

A description will be given of the basic operation of the Web server program. First, the Web server program has a basic function of sending text and images depending on a request from the Web browser. The request from the Web browser and a response of the Web server program may be summarized as follows.

The relationship between the Web browser and the Web server may be said to be that of a typical client-server system. The process is carried out by the Web server responding to the request from the Web browser. The communication between the Web browser and the Web server program is made using the Hyper Text Transfer Protocol (HTTP). The HTTP specifications are prescribed in Request for Comments (RFC), namely, RFC1945 (HTTP/1.0) and RFC2068 (HTTP/1.1).

The communication between the Web browser and the Web server program is made according to the HTTP, whereby the Web browser requests an HTML file with respect to the Web server program, and the Web server interprets the request and sends the HTML file to the Web browser. The Web browser requires functions such as interpreting a tag of the received HTML file and rendering the content, but the Web server program basically only needs to interpret the command from the Web browser and to send the corresponding HTML file.

[File Request (GET Command) From Web Browser]

Several kinds of commands are requested from the Web browser. However, a description will only be given to the most basic command, namely, a GET command. If a machine name started by the Web server program is “Web server”, an access to a file “index.html” on the “Web server” can be made by opening “http://Web server:6000/index.html”, where “6000” denotes a port number.

In this state, the Web browser uses a socket to form a connection with a server that is using the port 6000 on the machine Web server, and sends a command such as “GET/index.html HTTP/1.0[CR LF(line feed)” with respect to the Web server program, where the end of the line is a line feed code. In addition, although various added information follow the GET command, but a description thereof will be omitted.

By lastly adding a blank line which includes no characters other than the line feed code, it is possible to notify the end of the command to the Web server program. In a case where the Web browser makes an access to the Web server via a proxy server, the GET command becomes “GET http://Web server:6000/index.html HTTP/1.0[CR LF]”, and the proxy server makes access to the Web server as a substitute in place of the Web browser.

[Process (Web Server Program) of GET Command]

When the Web server program receives the GET command, the Web server program specifies the file that is requested from the GET command and sends the corresponding file (or target file). Prior to sending the file, the Web server program needs to send header information “HTTP/1.0 200 IK[CR LF]”.

The first line indicates that the GET command was correctly received and that the requested file will be sent. The second line is a blank line, and indicates the end of the header information. The requested file is sent subsequent to the second line, and the socket used to form the connection is closed when the sending of the file ends.

In a case where the Web browser returns error information due to causes such as the non-existence of the requested file, the following commands are sent according to the HTTP specifications, where the third line is an error message that is to be displayed by the Web browser.

HTTP/1.0 404 File Undetected[CR LF]
[CR LF]
<h2>Requested File Not Found.</h2>

The process of the Web server program is as described above. Of course, various other arrangements or agreements exist for the HTTP, but basically, the target file is requested by issuing the GET command from the Web browser, the request is interpreted by the Web server program, and the target file is sent with respect to the Web browser.

[Process of Web Server Program (Within Encapsulated Document)]

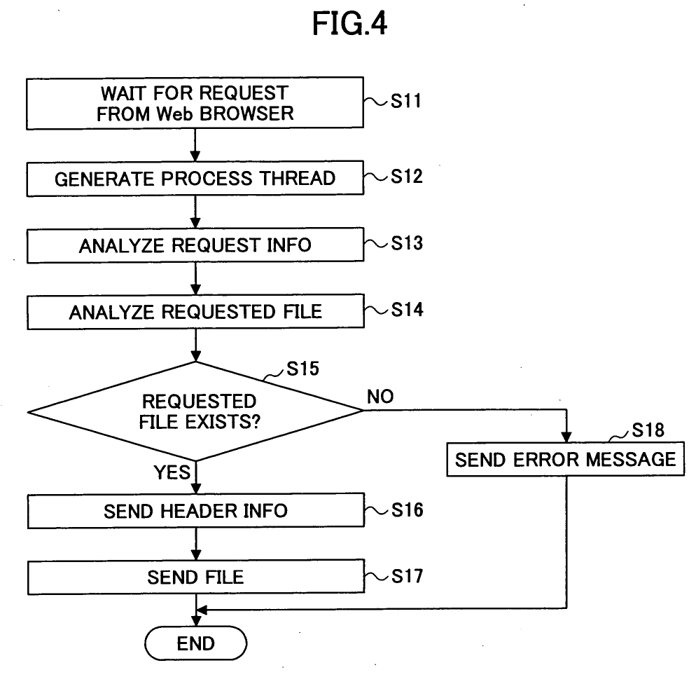

A description will now be given of the process of the Web server program within the document, by referring to FIG. 4. FIG. 4 is a flow chart for explaining the process of the Web server program. Similarly to the case described above, the file within the document is basically sent to the Web browser in response to the request from the Web browser. FIG. 4 shows a case where the operation is carried out in response to the request from the Web browser, by generating a thread at a time when the request is received from the Web browser.

In FIG. 4, a step S11 waits for and receives the request from the Web browser. When the request is received from the Web server, a step S12 generates a process thread. A step S13 analyzes information (request information) of the received request, and a step S14 analyzes a file (requested file) requested by the request. A step S15 decides whether or not the requested file exists, and a step S16 sends header information if the decision result in the step S15 is YES. After the step S16, a step S17 sends the requested file, and the process ends. On the other hand, if the decision result in the step S15 is NO, a step S18 sends an error message, and the process ends.

Therefore, the processes of sending the requested file when the request for the file is received from the Web browser and sending the error message if the requested file does not exist are carried out by the general Web server program as described above.

Next, a description will be given of the process when starting a plurality of documents having the Web server functions. First, a description will be given of a case where the plurality of documents having the Web server functions are started.

[Generation of Plurality of Sockets]

Starting a plurality of Web server programs means generating a plurality of sockets. In this case, there is a problem in that a plurality of sockets cannot be generated using the same port number. As described above, the Web server program generates (or creates) the socket from a set of IP address and port number, and waits for and receives the connection from the Web browser. Accordingly, when starting a plurality of Web server programs, it is necessary to start the Web server programs by changing the port number. Otherwise, a bind error would normally occur and make the socket generation impossible.

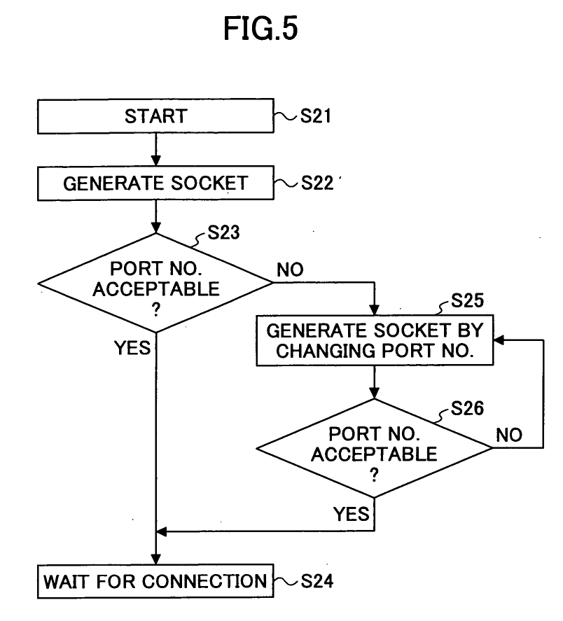

By changing the port number when generating the socket as shown in FIG. 5, it becomes possible for each of the plurality of Web server programs to generate the socket. FIG. 5 is a flow chart for explaining the starting of a plurality of Web server programs by generating a plurality of sockets. In other words, when the Web server program is started in a step S21 shown in FIG. 5, a step S22 generates the socket. A step S23 decides whether or not the port number is acceptable, and a step S24 waits for the connection if the decision result in the step S23 is YES.

On the other hand, if the decision result in the step S23 is NO, a step S25 changes the port number and generates the socket. A stehp S26 decides whether or not the port number is acceptable, and the step S24 waits for the connection if the decision result in the step S26 is YES. The process returns to the step S25 if the decision result in the step S26 is NO, so as to repeat the steps S25 and S26 until the decision result in the step S26 becomes YES. Therefore, each of the plurality of Web server programs can generate the socket.

However, according to this method, the Web browser that connects to the Web server programs must specify the address by changing the port number for each document. But since there is now way for the Web browser to know the port number with which the Web server program generated the socket, it would be more desirable to fix the port number. Hence, a description will now be given of a method that uses a single socket even when starting a plurality of documents.

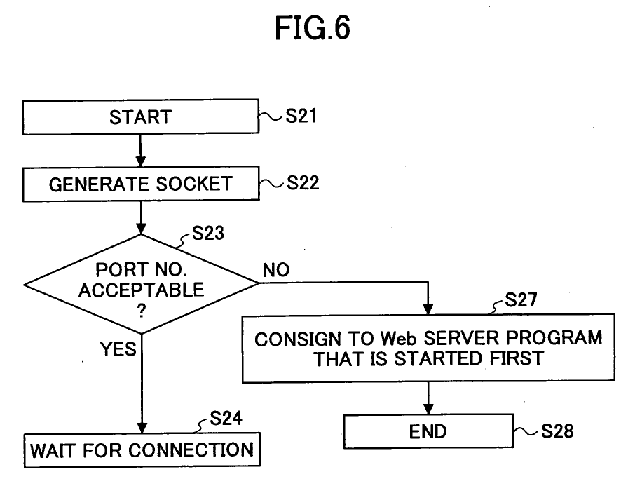

In other words, the method of generating the plurality of sockets is not the best mode from the practical point of view. Accordingly, a description will be given of the method that generates a single socket even when starting a plurality of documents having the Web server functions on a single machine, by referring to FIG. 6. FIG. 6 is a flow chart for explaining the starting of a plurality of Web server programs by generating a single socket. When the Web server program is started in the step S21 shown in FIG. 6, the step S22 generates the socket. The step S23 decides whether or not the port number is acceptable, and the step S24 waits for the connection if the decision result in the step S23 is YES. The process up to this point is the same as that shown in FIG. 5.

In this case, the document having the Web server functions and started first on the machine can generate the socket by the Web server program because there are no other documents using the port number. On the other hand, the documents having the Web server functions and started second or subsequently on the machine cannot generate the socket and an error is generated, since the port number of the socket that is to be generated is already used by the document that is started first on the machine.

In order to prevent such a generation of the error, a consignment request is sent from a sender Web server program with respect to the Web server program that is already started. The Web server program that receives the consignment request returns a response to notify the sender Web server program that this Web server program that is already started will accept the consignment request. More particularly, if the decision result in the step S23 is NO, a step S27 sends the consignment request to the Web server program that is started first on the machine, and the process ends in a step S28.

Hence, the documents having the Web server functions and started second or subsequently on the machine can consign the Web server functions with respect to the Web server program that is already started on the machine. As a result, even if the plurality of documents having the Web server functions are started on a single machine, it is sufficient to generate a single socket. Further, the Web server program that is already started and accepts the consignment request carries out the following process.

[Web Server Program Accepting Consignment Request]

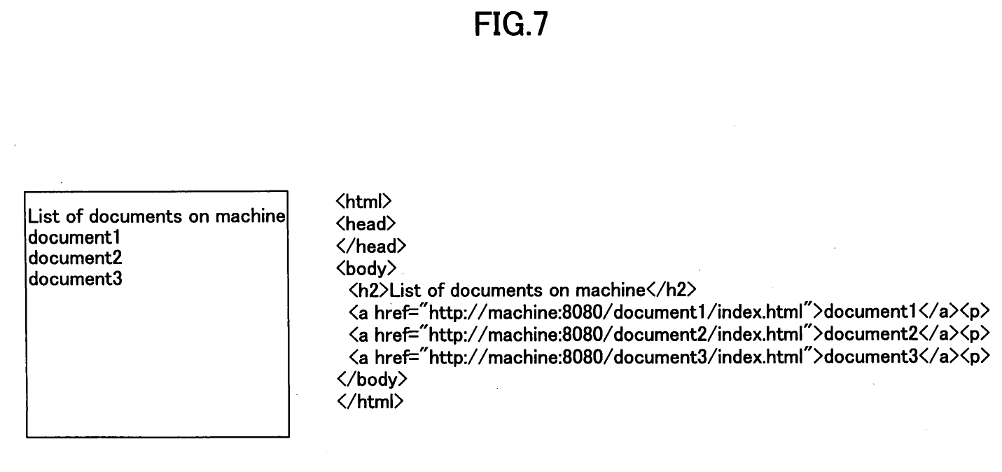

The Web server program that accepts the consignment request is assigned the process of sending to the Web browser not only the content within the document thereof but also the content within the document (Jar file) that is consigned by the consignment request. This Web server program that receives the consignment request generates an HTML document indicating a list of started documents as shown in FIG. 7. FIG. 7 is a diagram showing the HTML document indicating the list of started documents. FIG. 7 shows a case where the consignment request is received from two documents. In FIG. 7, the documents “document1” and the like are arbitrary, but are given names that are unique. The title may be extracted from the document and displayed, but it is necessary in this case to take measures so that the links will not indicate the same document.

Accordingly, when a plurality of documents are started in FIG. 7 and the machine name is denoted by “machine”, the HTML document indicating the list of started documents is displayed by opening “http://machine:8080/” by the Web browser.

The links of the list become as follows, for example, and the user can inspect the contents of different documents by clicking the document that is to be inspected using the mouse.

http://machine:8080/document1/index.html

http://machine:8080/document2/index.html

http://machine:8080/document3/index.html

Furthermore, as the process of the Web server program that receives the consignment request, this Web server program can acquire a command “GET/document3/index.html HTTP/1.1” when the Web browser opens “http://machine:8080/document3/index.html” in response to a click event made by the user using the mouse as shown in FIG. 7.

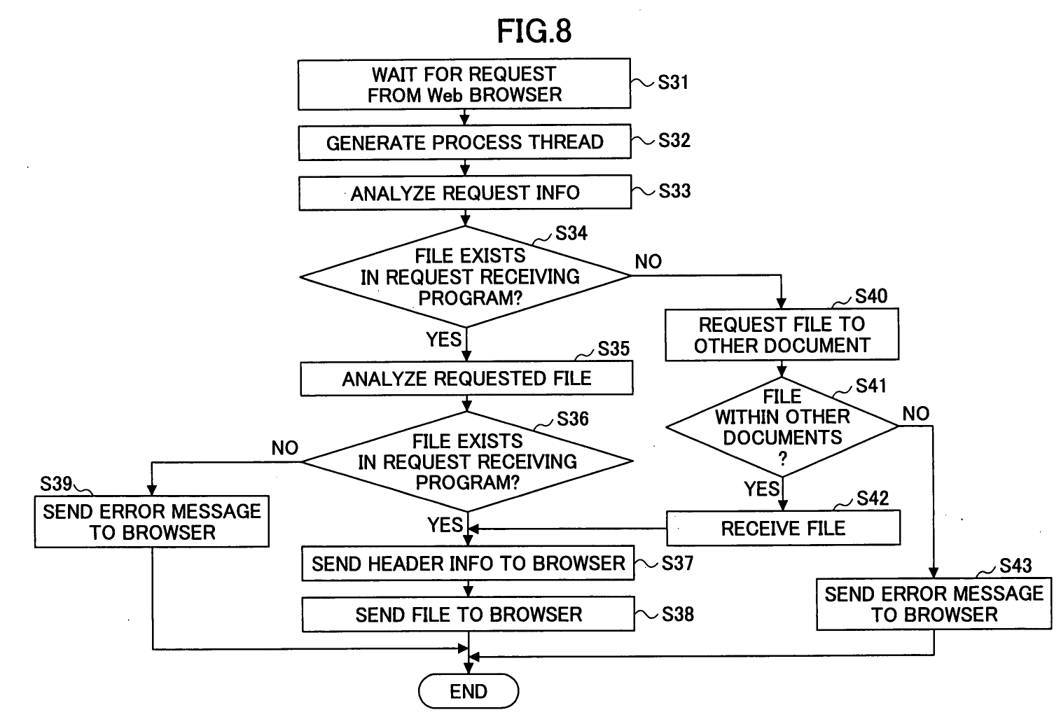

FIG. 8 is a flow chart for explaining the process of the Web server program that receives the consignment request. In FIG. 8, a step S31 waits for and receives a request from the Web browser. When the request from the Web browser is received, a step S32 generates a process thread, and a step S33 analyzes request information of the received request. These steps S31 through S33 are the same as the steps S11 through S13 shown in FIG. 4. A step S34 decides whether or not a file requested by the received request is within the document of the Web server program that receives the request and is carrying out the process. If the decision result in the step S34 is YES, a step S35 analysis the requested file.

After the step S35, a step S36 decides whether or not the requested file exists within the document of the Web server program that receives the request and is carrying out the process. If the decision result in the step S36 is YES, a step S37 sends the header information, a step S38 sends the requested file, and the process ends. On the other hand, if the decision result in the step S36 is NO, a step S39 sends an error message, and the process ends. Accordingly, the processes of sending the requested file when the request for the file is received from the Web browser and the requested file exists within the document of the Web server program that receives the request, and sending the error message if the requested file does not exist within the document of the Web server program that receives the request are carried out by the Web server program as described above. These steps S36 through S38 are the same as the steps S15 through S18 shown in FIG. 4.

On the other hand, if the decision result in the step S34 is NO, a step S40 requests the file to an other document by sending a consignment request, and a step S41 decides whether or not the requested file is within the other document. If the decision result in the step S41 is YES, a step S42 receives the file from the other document, and the process advances to the step S37. Hence, the step S37 sends the header information, the step S38 sends the requested file, and the process ends. On the other hand, if the decision result in the step S41 is NO, a step S43 sends an error message, and the process ends.

Therefore, the processes of sending the requested file from the other document when the request for the file is received from the Web browser and the requested file does not exist within the document of the Web server program that receives the request, and sending the error message if the requested file does not exist within the other document are carried out by the Web server program as described above. In other words, it is possible to judge from “document3” within the above command the document from which the request is received. Thus, by making access to the corresponding document “document3”, receiving “index.html” from the document “document3” and sending “index.html” to the Web browser, a single Web server program can undertake the processing of the contents of a plurality of documents.

That is, the Web server program that receives the consignment request analyzes the GET command, and carries out an operation that is the same as the normal operation shown in FIG. 4 if the content within the document of this Web server program is requested. On the other hand, if the content within an other document is requested as a result of analyzing the GET command, the Web server program requests the content to the other document, receives the file of the requested content from the other document, and sends the received file with respect to the Web browser.

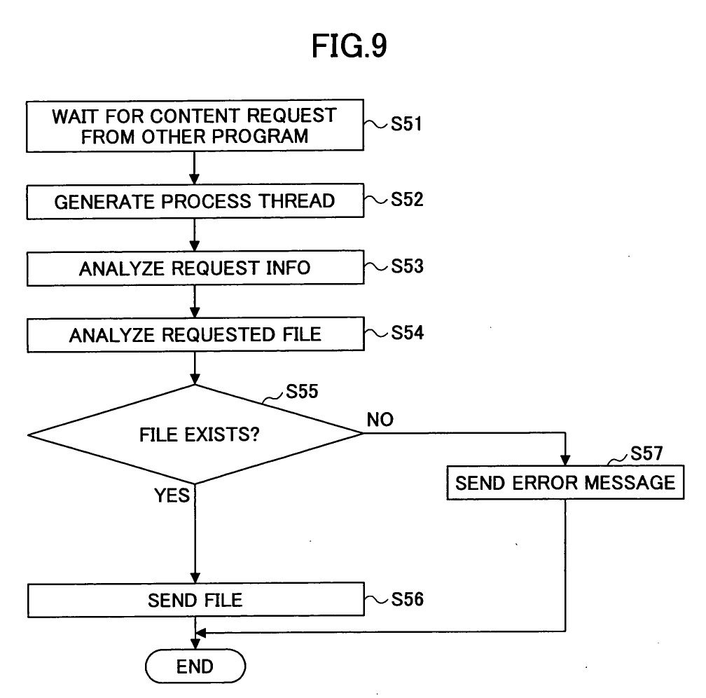

FIG. 9 is a flow chart for explaining the process of the Web server program that sends the consignment request. In FIG. 9, a step S51 waits for and receives a content request (or consignment request) from an other Web server program, that is, the sender Web server program. If the content request is received from the other Web server program, a step S52 generates a process thread. In addition, a step S53 analyzes request information of the received content request, and a step S54 analyzes the requested file requested by the content request. In addition, a step S55 decides whether or not the requested file exists in the consigned Web server program. If the decision result in the step S55 is YES, a step S56 sends the requested file, and the process ends. On the other hand, if the decision result in the step S55 is NO, a step S57 sends an error message to the sender Web server program, and the process ends.

Therefore, if the Web server program cannot generate the socket that waits for the connection from the Web browser, a socket that can accept the content request via another Web server program is generated and waits for the connection from the Web browser. In other words, if the socket that waits for the connection from the Web browser cannot be opened, a socket for making exchanges with the program that was able to open the socket is opened, so as to exchange information between the program that was able to open the socket and the program that was unable to open the socket, when a plurality of documents are started on the single machine (computer) in which these sockets are generated. If the Web server program receives the content request from the other Web server program, the Web server program analyzes the received content request, acquires the requested file according to the content request, and sends the requested file to the other Web server program that is the sender of the content request. If the requested file does not exist in the Web server program, the error message is sent to the other Web server program.

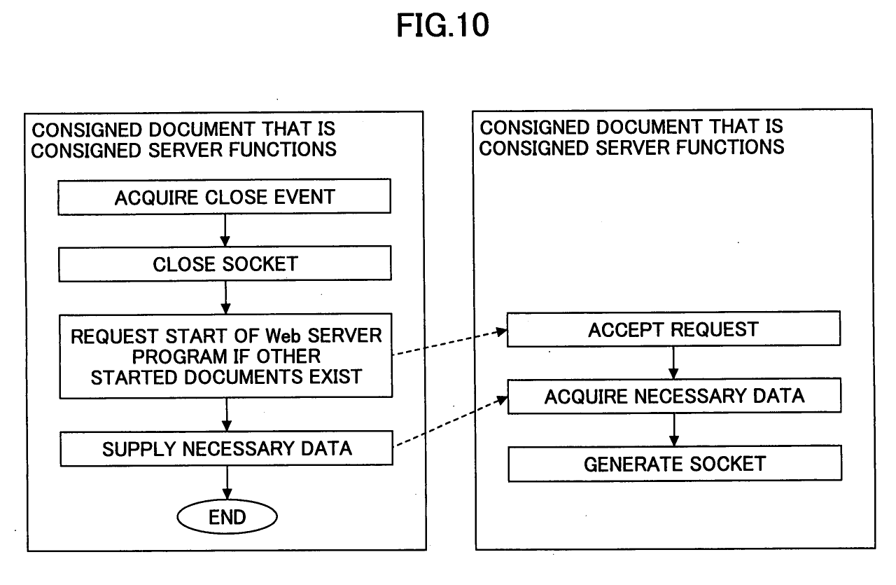

Next, a description will be given of the process for a case where the document having the consigned Web server functions is closed. In other words, if the program within the document having the consigned Web server functions acquires a close event, the socket is closed and the consignment is made to still another started document if any so as to cause this still another started document to generate (or create) the socket, as shown in FIG. 10. FIG. 10 is a diagram for explaining the processes of the Web server programs that receive the consignment request. In the case shown in FIG. 10, the information related to the started documents is also sent in addition to the consignment request as described above, with respect to this still another started document.

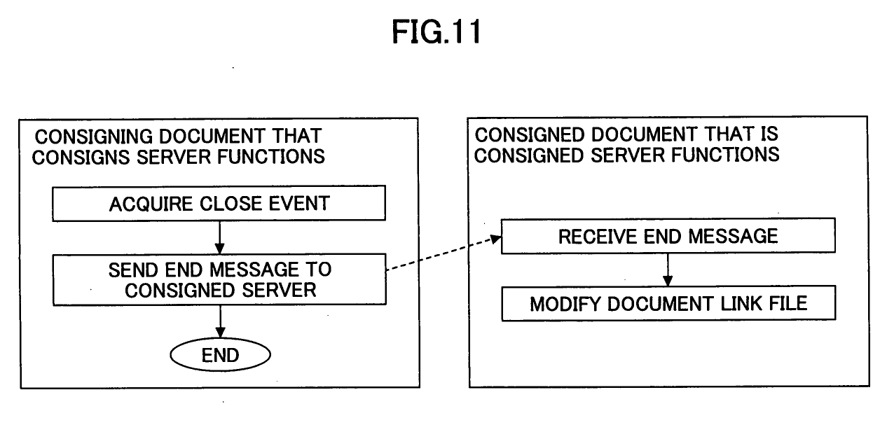

Next, a description will be given of the process for a case where the document having the Web server functions to be consigned is closed. In other words, if the Web server functions are consigned to another document, an end notification is made with respect to the consigned document, that is, the consigned Web server program, as shown in FIG. 11. FIG. 11 is a diagram for explaining the processes of the Web server programs that respectively send and receive the consignment request. In the case shown in FIG. 11, the consigned Web server program that is consigned the Web server functions and receives the end notification (or end information) from the consigning Web server program deletes the corresponding document from the document link information shown in FIG. 7 so as to remove this document from the link.

Therefore, according to this embodiment of the present invention, it is possible to enable the user to form a Web server or a global server by the user's machine by a simple means, without requiring intervention by an Internet service provider, so that information owned by the individual user can easily be disclosed.

Next, a description will be given of the method of creating the document having the Web server functions. First, a description will be given of an example of the description of the following manifest file.

Manifest-Version: 1.0

Main-Class: jp.co.ricoh.project.AppMain

Created-By: 1.3.1 (Sun Microsystems Inc.)

In the manifest file above, the second line indicates the class file name including the main function. By specifying the class file name, it is possible to determine the class file that is initially loaded at the time of starting. The third line of the manifest file indicates the Java version and the supplier. In addition, a single ZIP is formed from the manifest file, the content and the program file group (class file group), using “jar” as the file extension.

The ZIP forming method may include the following steps ST1 through ST7.

ST1: Read the file to be formed into the ZIP and store the file in a byte array;

ST2: Generate a file writer stream;

ST3: Generate a ZIP writer stream and supply the file writer stream;

ST4: Generate a ZIP entry and register the ZIP entry in the ZIP writer stream;

ST5: Write previous byte array into the ZIP writer stream;

ST6: Close ZIP entry; and

ST7: End process.

The steps ST1 through ST7 form the basic process of forming a single file into the ZIP, and the process is basically the same when forming a plurality of files into the ZIP. Accordingly, it is possible to treat a program group that provides the manifest file, the content and the Web server functions as a single archive file.

In addition, in the case of an environment in which a Software Development Kit (SDK) of Java is installed, it is possible to easily generate a Jar file by issuing a command such as “jar cvfm sample.jar manifest.mf*.*”. In other words, the Jar file can be created by inserting the command “jar cvfm sample.jar manifest.mf*.*” in an external program call character sequence of Runtime in Java programming.

Next, a description will be given of the method of creating and the method of editing the internal content in the present invention. In other words, if it is possible to edit using the Web browser, it will be convenient because this means that the internal content can be created and edited from anywhere that is connected to the network, as long as the document is started. For the sake of convenience, a description will be given of the editing method using the most basic Power On Self Test (POST) command. It was described above that the Web server program sends the file using the GET command, but the Web server program needs to have the ability (or capability) to process the POST command in order to make the editing. However, it is actually possible to make a contribution using the GET command.

Hence, the process of the POST command is carried out by the Common Gateway Interface (CGI) in most cases. In many cases, the CGI provides a bulletin board or a counter function by a data processing program. The CGI is written in the Practical Extraction and Report Language (Perl) in many cases, but the programming language is not limited to such as long as the POST command can be processed. In addition, the CGI may be embedded in the form of a script.

The POST command is a command that is issued by the Web browser mainly when contributing an article. In other words, the POST command is a command for sending data with respect to the Web server program. The exchange of data between the Web server program and the Web browser using the POST command may be made as follows.

First, the Web browser acquires an editing page using the GET command. For example, the editing page is the HTML that is sent from the Web server program when the link such as “create” within the document is clicked on the mouse. Of course, a log-in authentication may be made beforehand. The following is an example of the HTML acquired by the Web browser.

```
  <html>
  <head>
  </head>
  <body>
    <form action = “http://machine:8080/programs/post”
method = “post”>
    <p>
      <textarea name= “textarea” rows=5
cols=50></textarea><br>
      <input type = “submit” value = “send”><input type
= “reset” value = “reset”>
  <br>
    </p>
    </form>
  </body>
  </html>
```

According, when the Web browser receives the above HTML, and the user inputs characters in the text area and pushes a “send” button, the information written within the text area is supplied to the Web server program. The Web server program interprets the information written within the text area and supplied by the Web browser, and reflects the interpretation result to the content.

It is possible to directly edit the HTML. But in this case, the editing is made by calling the HTML editing program. In the case of the Java, for example, it is possible to generate a process tat calls an external program. The external program to be called is specified by the user.

When editing and newly creating the file, it should be noted that the ZIP file includes a header file written with the file name, the file size and the like that are formed into the ZIP. An error is generated if the edited information is simply packed into the ZIP file, unless the edited ZIP file is appropriately matched to the actual file. Hence, in order to avoid this error, it is necessary to acquire the file size after the editing and rewrite the file size of the header file or, newly create the Jar file itself. It is necessary to similarly cope with the insertion of a new file.

[Generation of RSS]

The RDF Site Summary (RSS) or, Rich Site Summary (RSS), is an XML format for writing the summary of the Web site as meta data in a simple manner. Recently, new information on Web sites are often provided in the form of the RSS. Many blogs also provide this function using the RSS. An RSS reader is known, which enables a list of articles of each site or blog to be acquired, by registering the RSS of each site or blog. The RSS is written when the content within the Jar file is changed. The RSS may be generated automatically by a simple script.

[Example of RSS]

```
<?xml version=“1.0” encoding=“utf-8” ?>
<rdf:RDF
  xmlns=“http://purl.org/rss/1.0/”
xmlns:rdf=“http://www.w3.org/1999/02/22-rdf-syntax-ns#”
xml:lang=“ja”>
<channel rdf:about=“http://machine.ricoh.co.jp/rss.rdf”>
  <title>Ricoh camera</title>
<link>http://machine.ricoh.co.jp</link>
  <description>Information on Ricoh's cameras is
provided.</description>
    <items>
      <rdf:Seq>
        <rdf:lirdf:resource=“http://machine.ricoh.co.jp/
camera/”/>
        <rdf:lirdf:resource=“http://machine.ricoh.co.jp/
docs/manual.html”/>
      </rdf:Seq>
    </items>
  </channel>
  <item rdf:about=“http://machine.ricoh.co.jp/camera/”>
    <title>Generations of cameras</title>
  <link>http://machine.ricoh.co.jp/camera/</link>
    <description>This is a list of generations of
cameras.</description>
  </item>
  <item rdf:about=“http://machine.ricoh.co.jp/docs/
manual. html”>
    <title>Manual of each camera</title>
  <link>http://machine.ricoh.co.jp/docs/manual.
html</link>
    <description>This is a list of manuals of generations
of products.</description>
  </item>
</rdf:RDF>
```

The RSS generation may include the following steps ST11 through ST13.

ST11: Read the source of the HTML;

ST12: Obtain necessary information such as the title, date and descriptive text; and

ST13: Output the RSS according to the syntax thereof.

By outputting the XML file of the RSS with the format of the example described above, it becomes possible to recognize or comprehend the update information by the RSS reader. It is necessary to add to the Web server program only the function of writing the RSS, and the file may be sent with respect to the program which requests the file by the GET command. In other words, the process is exactly the same as the process of the normal GET command.

[Integration of RSS of Plurality of Documents]

In the case where a plurality of documents are started on a single machine, a plurality of RSS files exist. In this case, a new single RSS file which integrates the plurality of RSS files is provided. In other words, the RSS reader or the like may read the new single RSS file and recognize or comprehend the update information of the plurality of documents.

[Method]

As described above, when starting a plurality of documents, the Web server program of the document that is started first provides the content amounting to the plurality of documents. The RSS file is provided similarly to the documents. The document which consigns the Web server functions generates the RSS file when the updating of the document is detected, and notifies the RSS file itself or its content with respect to the consigned program at the consigned end. For example, the content of the notified file may be as follows, which is similar to the example of the RSS described above.

```
<?xml version=“1.0” encoding=“utf-8” ?>
<rdf:RDF
  xmlns=“http://purl.org/rss/1.0/”
xmlns:rdf=“http://www.w3.org/1999/02/22-rdf-syntax-ns#”
xml:lang=“ja”>
<channel rdf:about=“http://machine.ricoh.co.jp/rss.rdf”>
  <title>Ricoh copying machine</title>
<link>http://machine.ricoh.co.jp</link>
  <description>Information on Ricoh's copying machines is
provided.</description>
    <items>
      <rdf:Seq>
        <rdf:lirdf:resource=“http://machine.ricoh.co.jp/
copier/”/>
      </rdf:Seq>
    </items>
  </channel>
  <item rdf:about=“http://machine.ricoh.co.jp/copier/”>
    <title>Generations of copying machines</title>
  <link>http://machine.ricoh.co.jp/copier/</link>
  <description>This is a list of generations of copying
machines.</description>
  </item>
</item>
</rdf:RDF>
```

When the file or information is received, the consigned program generates the following RSS file by merging the RSS file (first example) and the received file or information.

```
<?xml version=“1.0” encoding=“utf-8” ?>
<rdf:RDF
  xmlns=“http://purl.org/rss/1.0/”
xmlns:rdf=“http://www.w3.org/1999/02/22-rdf-syntax-ns#”
xml:lang=“ja”>
<channel rdf:about=“http://machine.ricoh.co.jp/rss.rdf”>
  <title>Document update information </title>
<link>http://machine.ricoh.co.jp</link>
  <description>Information on documents of the machine is
provided.</description>
    <items>
      <rdf:Seq>
        <rdf:lirdf:resource=“http://machine.ricoh.co.jp/
document 1/camera/”/>
        <rdf:lirdf:resource=“http://machine.ricoh.co.jp/
document1/docs/manual.html”/>
        <rdf:lirdf:resource=“http://machine.ricoh.co.jp/
document2/copier/”/>
      </drf:Seq>
    </items>
  </channel>
  <item rdf:about=“http://machine.ricoh.co.jp/document1/
camera/”>
    <title>Generations of cameras</title>
  <link>http://machine.ricoh.co.jp/document1/camera/
</link>
    <description>This is a list of generations of
cameras.</description>
  </item>
  <item rdf:about=“http://machine.ricoh.co.jp/document1/
docs/manual.html”>
    <title>Manual of each camera</title>
  <link>http://machine.ricoh.co.jp/document1/docs/manual.
html</link>
    <description>This is a list of manuals of generations
of products.</description>
  </item>
<item rdf:about=“http://machine.ricoh.co.jp/document2/
copier/”>
    <title>Generations of copying machines</title>
  <link>http://machine.ricoh.co.jp/document2/copier/
</link>
    <description>This is a list of generations of copying
machines.</description>
  </item>
</rdf:RDF>
```

The file that is generated is characterized in that, the resource “http://machine.ricoh.co.jp/camera/” that is specified changes to “http://machine.ricoh.co. jp/document1/camera/” as a result of the integration. In other words, the URL is changed for each document by creating a virtual hierarchical layers under the machine name.

Accordingly, it is possible to cope with a situation where the content name is the same among a plurality of documents. As described above in conjunction with the consigning Web server program and the consigned Web server program, it becomes possible to know the “document1” and the subsequent information from the GET command, thereby making it possible to return the corresponding file to the request source. In addition, a table indicating the relationship of the virtual hierarchical layer names such as “document1” and the documents may be stored when the Web server program receives the RSS file.

[Update Notification]

The RSS file may be generated as described above at the time of updating. However, instead of generating the RSS file, it is possible to make a notification to a specified machine such as the Web server or, to send a mail. But when sending the mail, it is necessary to urge the user to set the mail server or the like.

The user who holds the documents may be urged to set the following setting items of the mail server in advance.

SMTP server;

Receiving server such as POP and IMAP4 (non-essential);

User ID and password; and

Other detailed settings.

When the setting items of the mail server are set in advance, it is possible to notify by mail the updated information in text similarly to the RSS file description. The above settings are made by the owner of the document having the Web server functions. The user who wishes to receive the editing information of this document registers only the user's mail address. Hence, the Web server program can send the updated content with respect to the registered mail address.

The computer-readable program of the present invention causes the computer system to create documents having the Web server functions, according to the method of creating the documents having the Web server functions of the present invention. The computer system may be formed by a known general-purpose computer including an input part such as a keyboard and a mouse, a processor such as a CPU, and a display part. Hence, the present invention is applicable to various electronic apparatuses and equipments formed by the computer. In addition, the computer-readable program may be stored in any computer-readable storage medium capable of storing the computer-readable program in a computer-readable manner. The computer-readable storage medium may take the form of magnetic recording media, optical recording media, magneto-optical recording media and semiconductor memory devices.

According to the encapsulated document structure of the present invention, there are provided at least one digital information file configured to form a representation entity, a display information file configured to specify a structure and a display format of the digital information file, and a program file, interpreted and executed by a computer, and configured to include a function operation program that executes a predetermined function without referring to the digital information file, wherein the program file has Web server functions for sending a content within the digital information file to a Web browser in response to a request from the Web browser, and the program file and the digital information file are encapsulated within a single document. Therefore, it is possible enable a user to form a Web server or a global server by the user's machine by a simple means, without requiring intervention by an Internet service provider, so that information owned by the individual user can easily be disclosed.

In addition, according to the method of forming the document having the Web server functions of the present invention, there are provided the steps of describing a manifest file, specifying a class file within the manifest file, and encapsulating within a single document the manifest file and content, and a program file having Web server functions and forming the class file. Therefore, it is possible to enable a user to form a Web server or a global server by the user's machine by a simple means, without requiring intervention by an Internet service provider, so that information owned by the individual user can easily be disclosed.

Moreover, according to the computer-readable program of the present invention that causes a computer to create a document having Web server functions, there are provided a procedure causing the computer to input a description of a manifest file; a procedure causing the computer to input a specified class file within the manifest file; and a procedure causing the computer to encapsulate within a single document the manifest file and content, and a program file having Web server functions and forming the class file. Hence, it is possible to enable a user to form a Web server or a global server by the user's machine by a simple means, without requiring intervention by an Internet service provider, so that information owned by the individual user can easily be disclosed.

This application claims the benefit of a Japanese Patent Application No. 2005-223083 filed Aug. 1, 2005, in the Japanese Patent Office, the disclosure of which is hereby incorporated by reference.

Further, the present invention is not limited to these embodiments, but various variations and modifications may be made without departing from the scope of the present invention.

What is claimed is:

1. An encapsulated document structure comprising:
at least one digital information file configured to form a representation entity; and
a program file configured to include a Web server function that sends the digital information file to a Web browser in response to a request from the Web browser,
wherein the program file and the digital information file are encapsulated within a single document.

2. An encapsulated document structure comprising:
at least one digital information file configured to form a representation entity;
a display information file configured to specify a display format of the digital information file; and
a program file, interpreted and executed by a computer, and configured to include a function operation program that executes a predetermined function,
wherein the program file has Web server functions for sending the digital information file to a Web browser in response to a request from the Web browser, and the program file and the digital information file are encapsulated within a single document.

3. The encapsulated document structure as claimed in claim 2, wherein a digital information display program is configured to display the digital information file in the display format based on the display information file on a display part of the computer, and is encapsulated within a single document.

4. The encapsulated document structure as claimed in claim 1, wherein a program file having a content editing function to edit the digital information file is encapsulated within a single document.

5. The encapsulated document structure as claimed in claim 3, wherein a program file having an updated information sending function for sending update information related to the digital information file is encapsulated within a single document.

6. The encapsulated document structure as claimed in claim 1, wherein the program file having the Web server functions consigns the Web server functions to a Web server program if the Web server program is already started.

7. The encapsulated document structure as claimed in claim 6, wherein a program file having the Web server functions and including a function of receiving consignment of the Web server functions is encapsulated within a single document.

8. The encapsulated document structure as claimed in claim 1, wherein a program file having a meta information disclosing function for disclosing metal information related to a stored digital information file content is encapsulated within a single document.

9. The encapsulated document structure as claimed in claim 8, wherein a program file having a metal information integrating function for integrating metal information of documents started on the computer is encapsulated within a single document.

10. A method of creating a document having Web server functions, comprising:
describing a manifest file;
specifying a class file within the manifest file; and
encapsulating within a single document the manifest file and content, and a program file having Web server functions and forming the class file.

11. The method of creating the document having the Web server functions as claimed in claim 10, wherein the program file having the Web server functions consigns the Web server functions to a Web server program if the Web server program is already started.

12. The method of creating the document having the Web server functions as claimed in claim 11, wherein a program file having the Web server functions and including a function of receiving consignment of the Web server functions is encapsulated within a single document.

13. A computer-readable program for causing a computer to create a document having Web server functions, comprising:
a procedure causing the computer to input a description of a manifest file;
a procedure causing the computer to input a specified class file within the manifest file; and
a procedure causing the computer to encapsulate within a single document the manifest file and content, and a program file having Web server functions and forming the class file.

14. The computer-readable program as claimed in claim 13, comprising:
a procedure causing the computer to consign the Web server functions from the program file having the Web server functions to a Web server program if the Web server program is already started.

15. The computer-readable program as claimed in claim 14, comprising:
a procedure causing the computer to encapsulate within a single document a program file having the Web server functions and including a function of receiving consignment of the Web server functions.
